(19) United States
(12) Patent Application Publication
(10) Pub. No.: US 2016/0357051 A1
(43) Pub. Date: Dec. 8, 2016

(54) TWIN-LCD STRUCTURE CAPABLE OF PREVENTING ITS TWO LCDS FROM INTERFERING WITH EACH OTHER

(71) Applicant: LITEMAX ELECTRONICS INC., New Taipei City (TW)

(72) Inventor: KUO-YOU CHEN, NEW TAIPEI CITY (TW)

(21) Appl. No.: 14/728,219

(22) Filed: Jun. 2, 2015

(51) Int. Cl. G02F 1/1333; G02F 1/1335

(52) U.S. Cl. CPC G02F 1/133305; G02F 1/133308; G02F 1/133504; G02F 1/133553; G02F 2001/133507; G02F 2001/133302

(57) ABSTRACT

A twin-LCD structure capable of preventing its two LCDs from interfering with each other includes a frame; a flexible liquid crystal unit disposed in the frame; a planar liquid crystal unit disposed beside the frame, having a transparent observation portion, and corresponding in position to the flexible liquid crystal unit; and an interference-preventing unit affixed to a surface of the flexible liquid crystal unit and disposed between the flexible liquid crystal unit and the planar liquid crystal unit, wherein the flexible liquid crystal unit and the planar liquid crystal unit are separated by a distance of less than 0.5 cm. The interference-preventing unit enables the flexible liquid crystal unit and the planar liquid crystal unit to be so close to each other that the twin-LCD structure is not only downsized but is also unlikely to produce interference.

### FIELD OF TECHNOLOGY

The present invention relates to twin-LCD structures, and more particularly, to a twin-LCD structure capable of preventing its two LCDs from interfering with each other.

### BACKGROUND

Two liquid crystal displays (LCDs) mounted on a frame always interfere with each other optically, and in consequence the LCDs in operation exhibit moiré and lattice fringes.

The prior art put forth in attempt to solve problems with interference entails spacing apart two LCDs by a long distance to reduce interference at the expense of an increase in the overall space required. As a result, the aforesaid prior art is inapplicable to small-sized devices.

In the situation where one of the two LCDs is a flexible LCD, the two LCDs must be separated by a distance of at least 1 cm in order to effectively reduce interference. The required distance between the two LCDs increases with the curvature of the flexible LCD.

Accordingly, it is imperative to provide a twin-LCD structure which does not generate optical interference even when applied to small-sized devices.

### SUMMARY

It is an objective of the present invention to provide a twin-LCD structure capable of preventing its two LCDs from interfering with each other but unlikely to generate optical interference even when applied to small-sized devices.

In order to achieve the above and other objectives, the present invention provides a twin-LCD structure capable of preventing its two LCDs from interfering with each other. The twin-LCD structure comprises a frame, a flexible liquid crystal unit, a planar liquid crystal unit and an interference-preventing unit.

The flexible liquid crystal unit is disposed in the frame. The planar liquid crystal unit is disposed beside the frame. The planar liquid crystal unit comprises a transparent observation portion and corresponds in position to the flexible liquid crystal unit. The interference-preventing unit is affixed to a surface of the flexible liquid crystal unit and disposed between the flexible liquid crystal unit and the planar liquid crystal unit. The flexible liquid crystal unit and the planar liquid crystal unit are separated by a distance of less than 0.5 cm.

As regards the twin-LCD structure of the present invention, the interference-preventing unit is a diffusion film or a reflecting brightness-enhancing film.

As regards the twin-LCD structure of the present invention, the flexible liquid crystal unit and the planar liquid crystal unit are separated by a distance of less than 0.1 cm.

In conclusion, due to its aforesaid structure, the twin-LCD structure of the present invention is characterized is that the flexible liquid crystal unit and the planar liquid crystal unit are close to each other to therefore downsize the twin-LCD structure and preclude interference.

### BRIEF DESCRIPTION

Objectives, features, and advantages of the present invention are hereunder illustrated with specific embodiments in conjunction with the accompanying drawings, in which:

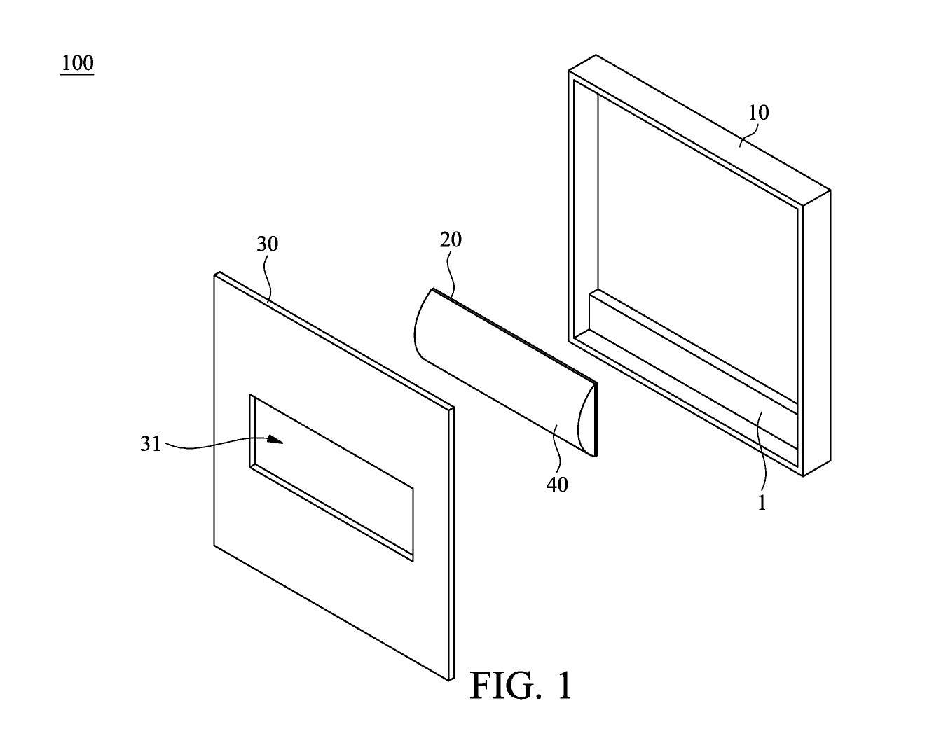

FIG. 1 is a schematic view of a twin-LCD structure capable of preventing its two LCDs from interfering with each other according to the present invention;

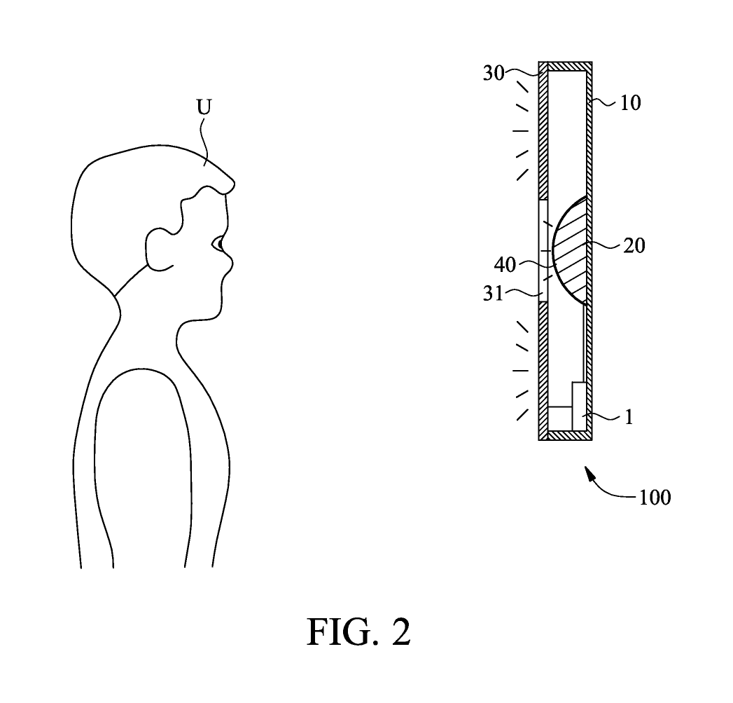

FIG. 2 is a cross-sectional view of the twin-LCD structure of the present invention; and

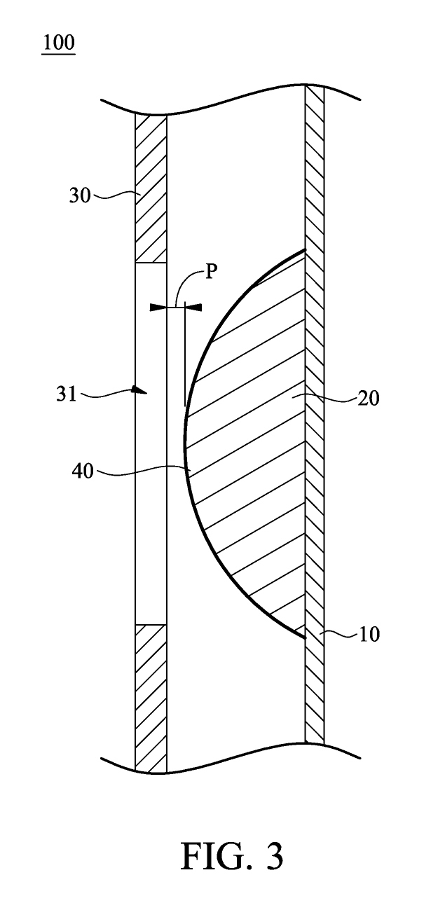

FIG. 3 is a partial enlarged cross-sectional view of the twin-LCD structure of the present invention.

### DETAILED DESCRIPTION

Referring to FIG. 1 through FIG. 3, there are shown schematic views of a twin-LCD structure 100 capable of preventing its two liquid crystal displays (LCDs) from interfering with each other. The twin-LCD structure 100 comprises a frame 10, a flexible liquid crystal unit 20, a planar liquid crystal unit 30, and an interference-preventing unit 40.

The frame 10 is a conventional casing for use in a LCD assembly process. Referring to FIG. 1, the frame 10 is rectangular and the like.

The flexible liquid crystal unit 20 is disposed in the frame 10 and electrically connected to a control unit 1 so as to control the operation of the flexible liquid crystal unit 20.

The planar liquid crystal unit 30 is disposed beside the frame 10. The planar liquid crystal unit 30 has a transparent observation portion 31 and corresponds in position to the flexible liquid crystal unit 20 such that a user U can observe the information exhibited on the flexible liquid crystal unit 20 and the planar liquid crystal unit 30 concurrently. The planar liquid crystal unit 30 is electrically connected to the control unit 1 so as to control the operation of the flexible liquid crystal unit 20.

The interference-preventing unit 40 is affixed to a surface of the flexible liquid crystal unit 20 and disposed between the flexible liquid crystal unit 20 and the planar liquid crystal unit 30. The interference-preventing unit 40 is a diffusion film or a reflecting brightness-enhancing film.

Due to the aforesaid technical features of the twin-LCD structure 100, the interference-preventing unit 40 is effective in reducing the mutual interference arising from the flexible liquid crystal unit 20 and the planar liquid crystal unit 30. Hence, even though the flexible liquid crystal unit 20 and the planar liquid crystal unit 30 are separated by a distance P of less than 0.5 cm, the user U is unlikely to perceive any moiré and lattice fringes displayed on the flexible liquid crystal unit 20 and the planar liquid crystal unit 30 in operation. What is more, the twin-LCD structure 100 is characterized in that: the flexible liquid crystal unit 20 and the planar liquid crystal unit 30 are separated by a distance P of less than 0.1 cm to thereby downsize the twin-LCD structure 100 by reducing the dimensions of the frame 10, thus rendering the twin-LCD structure 100 applicable to small-sized devices or apparatuses.

Referring to FIG. 2 and FIG. 3, to facilitate description, internal elements and structures, for example, a layer structure of a liquid crystal unit and a back light module, of the flexible liquid crystal unit 20 and the planar liquid crystal unit 30 are omitted from the diagrams.

In conclusion, the present invention provides a twin-LCD structure capable of preventing its two LCDs from interfering with each other. The twin-LCD structure is characterized in that: an interference-preventing unit is provided to ensure that a flexible liquid crystal unit and a planar liquid crystal unit are close to each other to therefore downsize the twin-LCD structure and preclude interference. Hence, the twin-LCD structure is applicable to small-sized devices or apparatuses.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A twin-LCD structure capable of preventing its two LCDs from interfering with each other, the twin-LCD structure comprising:
a frame;
a flexible liquid crystal unit disposed in the frame;
a planar liquid crystal unit disposed beside the frame, having a transparent observation portion, and corresponding in position to the flexible liquid crystal unit; and
an interference-preventing unit affixed to a surface of the flexible liquid crystal unit and disposed between the flexible liquid crystal unit and the planar liquid crystal unit,
wherein the flexible liquid crystal unit and the planar liquid crystal unit are separated by a distance of less than 0.5 cm.

2. The twin-LCD structure of claim 1, wherein the interference-preventing unit is one of a diffusion film and a reflecting brightness-enhancing film.

3. The twin-LCD structure of claim 1, wherein the flexible liquid crystal unit and the planar liquid crystal unit are separated by a distance of less than 0.1 cm.

4. The twin-LCD structure of claim 2, wherein the flexible liquid crystal unit and the planar liquid crystal unit are separated by a distance of less than 0.1 cm.

1. A twin-LCD structure capable of preventing its two LCDs from interfering with each other, the twin-LCD structure comprising:
a frame;
a flexible liquid crystal unit disposed in the frame;
a planar liquid crystal unit disposed beside the frame, having a transparent observation portion, and corresponding in position to the flexible liquid crystal unit; and
an interference-preventing unit affixed to a surface of the flexible liquid crystal unit and disposed between the flexible liquid crystal unit and the planar liquid crystal unit,
wherein the flexible liquid crystal unit and the planar liquid crystal unit are separated by a distance of less than 0.5 cm.

2. The twin-LCD structure of claim 1, wherein the interference-preventing unit is one of a diffusion film and a reflecting brightness-enhancing film.

3. The twin-LCD structure of claim 1, wherein the flexible liquid crystal unit and the planar liquid crystal unit are separated by a distance of less than 0.1 cm.

4. The twin-LCD structure of claim 2, wherein the flexible liquid crystal unit and the planar liquid crystal unit are separated by a distance of less than 0.1 cm.
